(19) United States
(12) Patent Application Publication
(10) Pub. No.: US 2016/0353538 A1
(43) Pub. Date: Dec. 1, 2016

(54) OPTOELECTRONIC CIRCUIT WITH LIGHT-EMITTING DIODES

(71) Applicant: COMMISSARIAT A L'ENERGIE ATOMIQUE ET AUX ENERGIES ALTERNATIVES, Paris (FR)

(72) Inventor: François Ayel, Saint Blaise Du Buis (FR)

(73) Assignee: Commissariat à I'Énergie Atomique et aux Énergies Alternatives, Paris (FR)

(21) Appl. No.: 15/117,470

(22) PCT Filed: Feb. 17, 2015
(86) PCT No.: PCT/EP2015/053338

§ 371 Date: Aug. 9, 2016

(30) Foreign Application Priority Data
Feb. 17, 2014 (FR) 1451230

(51) Int. Cl. H05B 33/08

(52) U.S. Cl. CPC H05B 33/0845; H05B 33/0827; H05B 33/0815

(57) ABSTRACT

An optoelectronic circuit including a full-wave rectifier circuit including light-emitting diodes and a circuit limiting the current passing through the light-emitting diodes.

The present patent application claims the benefit of French patent application FR14/51230 which will be incorporated herein by reference.

### BACKGROUND

The present description relates to an optoelectronic circuit, particularly an optoelectronic circuit comprising light-emitting diodes.

### DISCUSSION OF THE RELATED ART

It is desirable to be able to power an optoelectronic circuit comprising light-emitting diodes with an AC voltage, particularly a sinusoidal voltage, for example, the mains voltage.

FIG. 1 shows an optoelectronic circuit 10 comprising input terminals IN1 and IN2 having an AC voltage VIN applied therebetween. Optoelectronic circuit 10 further comprises a rectifying circuit 12 comprising a diode bridge 14, receiving voltage VIN and supplying a rectified voltage VALIM which powers light-emitting diodes 16, for example, series-connected. Call IALIM the current flowing through light-emitting diodes 16.

FIG. 2 shows a curve CVALIM of variation of power supply voltage VALIM and a curve CIALIM of variation of power supply current IALIM along time for an example where AC voltage VIN corresponds to a sinusoidal voltage. However, voltage VIN may be non-sinusoidal. As an example, voltage VIN may be supplied by a regulation circuit, particularly using triacs. Even if the regulator element is powered with a sinusoidal voltage, voltage VIN generally does not have a sinusoidal shape. When voltage VALIM is greater than the sum of the threshold voltages of light-emitting diodes 16, light-emitting diodes 16 become conductive and substantially behave as resistors. Power supply current IALIM then follows power supply voltage VALIM.

A disadvantage is that power supply current IALIM is not constant. This causes variations of the light intensity provided by light-emitting diodes 16, which may be perceived by an observer.

A current-limiting circuit may be interposed between rectifying circuit 12 and light-emitting diodes 16 to keep the power supply current at a substantially constant level. The structure of the optoelectronic circuit can then be relatively complex and the bulk of the optoelectronic circuit may be significant. Further, it may be difficult to at least partly form the rectifying circuit and the current-limiting circuit in integrated fashion with the light-emitting diodes to still further decrease the bulk of the optoelectronic circuit.

### SUMMARY

An object of an embodiment is to overcome all or part of the disadvantages of the previously-described optoelectronic circuits.

Another object of an embodiment is to decrease the bulk of the optoelectronic circuit.

Another object of an embodiment is to decrease the variations of the light intensity provided by the optoelectronic circuit.

Another object of an embodiment is to be able to form a significant number of components of the optoelectronic circuit in integrated fashion.

Thus, an embodiment provides an optoelectronic circuit comprising:

a fullwave rectifying circuit comprising light-emitting diodes; and

a current-limiting circuit flowing through the light-emitting diodes.

According to an embodiment, the circuit comprises first and second input terminals intended to receive an AC voltage and the fullwave rectifying circuit comprises:

first, second, third, and fourth branches, the first and second branches having a first common node connected to the first input terminal, the third and fourth branches having a second common node connected to the second input terminal, the first and third branches having a third common node and the second and fourth branches having a fourth common node;

a first assembly of light-emitting diodes assembled on the first branch in the forward direction from the third node to the first node; and

a second assembly of light-emitting diodes assembled on the second branch in the forward direction from the first node to the fourth node or on the third branch in the forward direction from the third node to the second node,

and the current-limiting circuit flowing through the light-emitting diodes comprises at least one component assembled between the third node and the fourth node.

According to an embodiment, the fullwave rectifying circuit further comprises a third assembly of light-emitting diodes assembled on the third branch in the forward direction from the third node to the second node.

According to an embodiment, the second assembly of light-emitting diodes is assembled on the second branch and the fullwave rectifying circuit comprises a fourth assembly of light-emitting diodes assembled on the fourth branch in the forward direction from the second node to the fourth node.

According to an embodiment, the current-limiting circuit comprises an inductance assembled between the third node and the fourth node.

According to an embodiment, the current-limiting circuit comprises a sensor of the current flowing through the inductance.

According to an embodiment, the current-limiting circuit comprises at least one first switch provided on one of the first or third branches, between the third and fourth nodes, between the first input terminal and the first node or between the second input terminal and the second node and a unit for controlling the turning off and the turning on of the first switch, the control unit being connected to the sensor.

According to an embodiment, the current-limiting circuit is capable of keeping the current between a first threshold and a second threshold when the first assembly of light-emitting diodes or the second assembly of light-emitting diodes is conductive.

According to an embodiment, the optoelectronic circuit further comprises means for modifying the first and second thresholds.

According to an embodiment, the control unit is capable of controlling the turning-off of the first switch when the current flowing through the light-emitting diodes of the first assembly or of the second assembly is greater than the first threshold.

According to an embodiment, the control unit is capable of controlling the turning-on of the first switch when the current flowing through the light-emitting diodes of the first assembly or of the second assembly is smaller than the second threshold.

According to an embodiment, the first switch is assembled on the first branch or the fourth branch and the current-limiting circuit comprises a second switch assembled on the second branch or the third branch, the control unit being capable of controlling the turning-off of the first switch when the current flowing through the light-emitting diodes of the first assembly is greater than the first threshold and the AC voltage is of a first sign, and being capable of controlling the turning-off of the second switch when the current flowing through the light-emitting diodes of the second assembly is greater than the first threshold and the AC voltage is of a second sign opposite to the first sign.

### BRIEF DESCRIPTION OF THE DRAWINGS

The foregoing and other features and advantages will be discussed in detail in the following non-limiting description of specific embodiments in connection with the accompanying drawings, among which:

FIG. 1, previously described, is an electric diagram of an example of an optoelectronic circuit comprising light-emitting diodes;

FIG. 2, previously described, is a timing diagram of the voltage and of the current for supplying the light-emitting diodes of the optoelectronic circuit of FIG. 1;

FIG. 3 is an electric diagram of an embodiment of an optoelectronic circuit comprising light-emitting diodes;

FIGS. 4 and 5 illustrate two layouts of the light-emitting diodes of the optoelectronic circuit of FIG. 3;

FIG. 6 is a more detailed electric diagram of a portion of the optoelectronic circuit of FIG. 3;

FIG. 7 shows a curve of the variation of the input voltage of the optoelectronic circuit of FIG. 3 and a curve of the variation of the power supply current of an inductance of the optoelectronic circuit of FIG. 3;

FIG. 8 shows a detail of the curve of variation of the power supply current of the inductance of FIG. 7 and of the curves of variation of currents flowing through overall light-emitting diodes of the optoelectronic circuit of FIG. 3;

FIG. 9 is a more detailed electric diagram of a portion of the optoelectronic circuit of FIG. 3;

FIGS. 10, 11, and 12 are electric diagrams of other embodiments of an optoelectronic circuit comprising light-emitting diodes;

FIG. 13 is a drawing similar to FIG. 8 obtained with the optoelectronic circuit of FIG. 12;

FIG. 14 shows an embodiment of an overall light-emitting diode; and

FIGS. 15 to 18 each show an equivalent electric diagram of the overall light-emitting diode of FIG. 13 in four operating configurations.

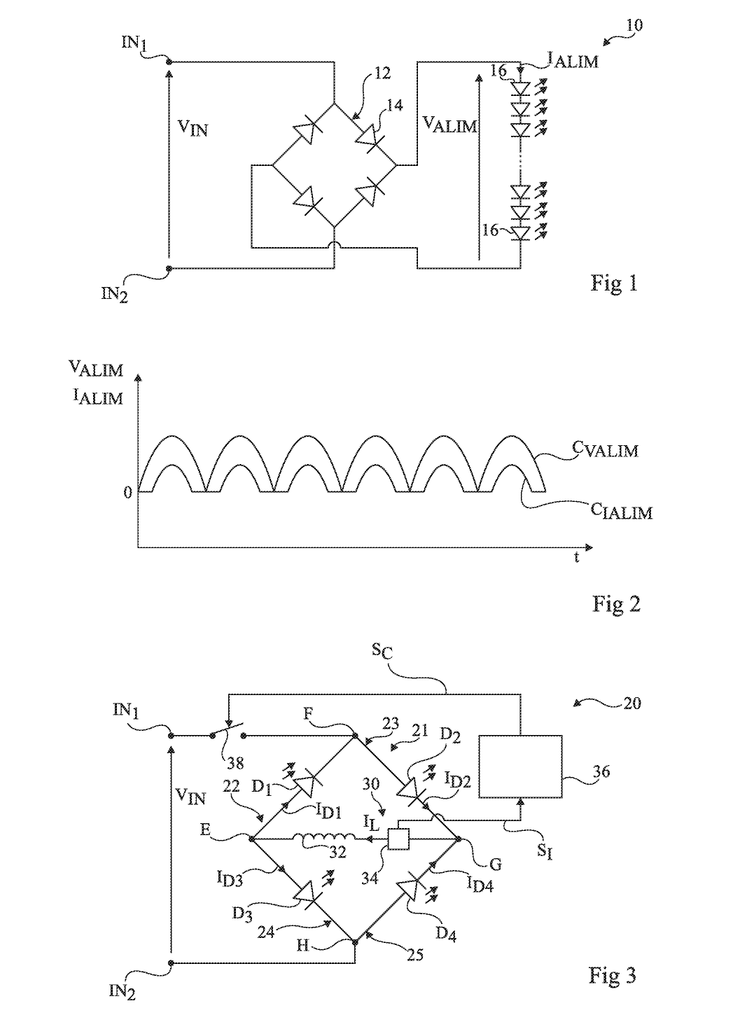

### DETAILED DESCRIPTION

For clarity, the same elements have been designated with the same reference numerals in the various drawings and, further, the various drawings are not to scale. In the following description, unless otherwise indicated, terms “substantially”, “approximately”, and “in the order of” mean “to within 10%”.

According to an embodiment, the light-emitting diodes of the optoelectronic circuit are used to form the diode bridge of the rectifying circuit. This enables to decrease the total bulk of the optoelectronic circuit. Further, a current-limiting circuit is directly integrated to the diode bridge. This enables to decrease the variations of the power supply current of the light-emitting diodes while decreasing the total bulk of the optoelectronic circuit.

FIG. 3 shows an embodiment of an optoelectronic circuit 20 comprising two input terminals IN1 and IN2 receiving input voltage VIN. As an example, input voltage VIN may be a sinusoidal voltage having a frequency, for example, in the range from 10 MHz to 1 MHz. Voltage VIN corresponds, for example, to the mains voltage which may possibly have been modified by a regulation circuit. For example, the mains voltage may be lowered or chopped by the regulation circuit.

Circuit 20 comprises a fullwave rectifying circuit 21 comprising a diode bridge formed of four assemblies D1, D2, D3 and D4 of light-emitting diodes, called overall light-emitting diodes in the following description. Each overall light-emitting diode is formed of the series and/or parallel assembly of a plurality of elementary light-emitting diodes. Overall light-emitting diode D1 is assembled on a first branch 22 between a node E and a node F in the forward direction from node E to node F. Overall light-emitting diode D2 is assembled on a second branch 23 between node F and a node G in the forward direction from node F to node G. Overall light-emitting diode D3 is assembled on a third branch 24 between node E and a node H in the forward direction from node E to node H. Overall light-emitting diode D4 is assembled on a fourth branch 25 between node H and node G in the forward direction from node H to node G.

Preferably, all the light-emitting diodes of optoelectronic circuit 20 belong to one of overall light-emitting diodes D1, D2, D3 and D4. Overall light-emitting diodes D1, D2, D3 and D4 may comprise the same number of elementary light-emitting diodes or different numbers of elementary light-emitting diodes.

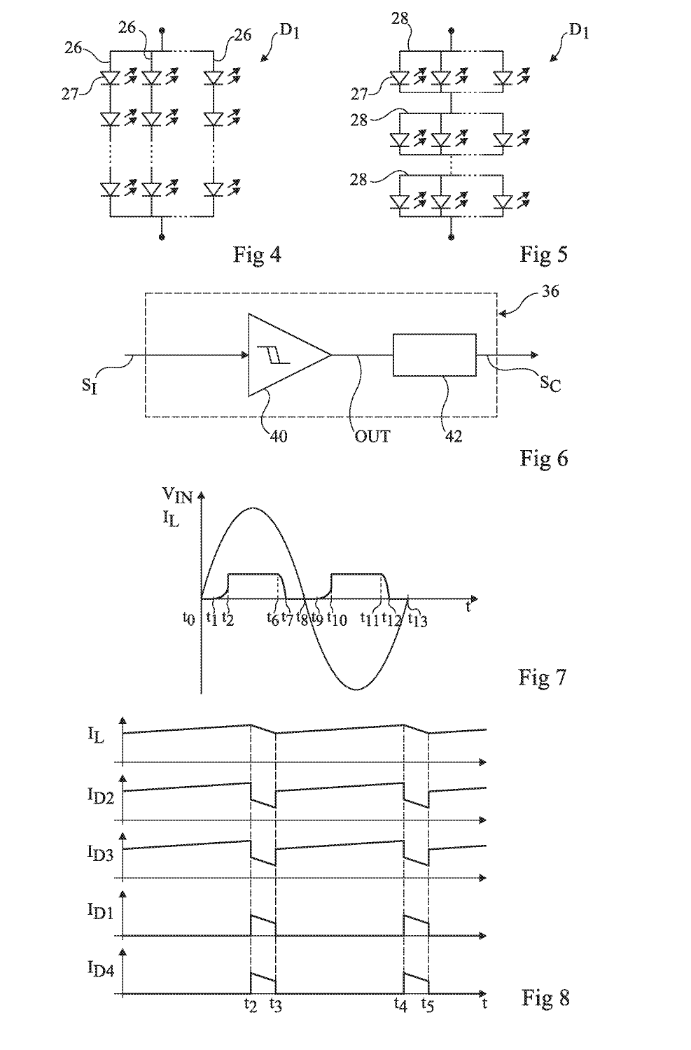

FIG. 4 shows an embodiment of overall light-emitting diode D1. Overall light-emitting diode D1 comprises R branches 26 assembled in parallel, each branch comprising S series-connected elementary light-emitting diodes 27, R and S being integers greater than or equal to 2.

FIG. 5 shows another embodiment of overall light-emitting diode D1. Overall light-emitting diode D1 comprises P series-connected blocks 28, each block comprising Q elementary light-emitting diodes 27 assembled in parallel, P and Q being integers greater than or equal to 2 and Q being likely to vary from one block to the other.

Overall light-emitting diodes D2, D3 and D4 may have a structure similar to that of overall light-emitting diode D1 shown in FIG. 4 or 5.

Returning to FIG. 3, optoelectronic circuit 20 comprises a current-limiting circuit 30 comprising an inductance 32 assembled between nodes E and G. As an example, inductance 32 has a value in the range from 0.1 μH to 10 μH. Call IL, ID1, ID2, ID3 and ID4 the current respectively flowing through inductance 32, overall light-emitting diode D1, overall light-emitting diode D2, overall light-emitting diode D3, and overall light-emitting diode D4. Current-limiting circuit 30 further comprises a current sensor 34 capable of supplying a signal SI representative of current IL to a control unit 36. Current-limiting circuit 30 further comprises a switch 38 provided between input terminal IN1 and node E and controlled by a signal SC supplied by control unit 36. Node H is connected to input terminal IN2. Control unit 36 may be formed by a dedicated circuit.

According to an embodiment, control unit 36 is capable of ordering the turning-off and the turning-on of switch 38 so that current IL remains between a lower threshold IINF and an upper threshold ISUP. Upper threshold ISUP is greater than lower threshold IINF. Lower threshold IINF is greater than 0 A. As an example, current thresholds IINF and ISUP may be from a few milliamperes to several hundreds of milliamperes. FIG. 6 is an electric diagram of an embodiment of control unit 36. Control unit 36 may comprise a hysteresis comparator 40 receiving signal SI representative of current IL and supplying a signal OUT capable of taking two values OUT+ and OUT−. As an example, when signal SI increases, signal OUT is at value OUT− when current IL is smaller than threshold ISUP and switches to value OUT+ when current IL becomes greater than threshold ISUP. When current IL decreases, signal OUT is at value OUT+ when current IL is greater than threshold ISUP and switches to value OUT− when current IL becomes smaller than threshold ISUP. Control unit 36 comprises a shaping unit 42 receiving signal OUT and supplying signal SC.

Switch 38 is for example a bidirectional switch based on transistors, particularly on field-effect metal-oxide gate transistors or enrichment (normally on) or depletion (normally off) MOS transistors.

Elementary light-emitting diodes 27 are for example planar light-emitting diodes or light-emitting diodes formed from three-dimensional elements, particularly semiconductor microwires or nanowires, comprising a semiconductor material based on a compound mainly comprising a group-III element and a group-V element (for example, gallium nitride GaN), called III-V compound hereafter, or mainly comprising at least one group-II element and one group-VI element (for example zinc oxide ZnO), called II-VI compound hereafter.

Advantageously, switch 38 may be formed based on a III-V compound, for example, gallium nitride GaN. In this case, switch 38 may be formed in integrated fashion with the light-emitting diodes.

FIG. 7 is a timing diagram of input voltage VIN and of current IL. As an example, voltage VIN is a sinusoidal voltage. FIG. 8 is a detail view of the curve of variation of current IL of FIG. 7 and further shows curves of the variation of currents ID1, ID2, ID3 and ID4. Times t0 to t13 are successive times.

An embodiment of a method of controlling switch 38 during a positive halfwave and a negative halfwave of input voltage VIN will now be described.

Input voltage VIN increases from zero at time t0. Switch 38 is initially on. Overall light-emitting diodes D2 and D3 are forward-biased while overall light-emitting diodes D1 and D4 are reverse-biased. When input voltage VIN is sufficiently high at time t1, the current starts flowing between terminals IN1 and IN2 successively through overall light-emitting diode D2, through inductance 32, from node G to node E, and through light-emitting diode D3.

At time t2, current IL exceeds threshold ISUP. Control unit 36 then orders the turning-off of switch 38, which causes a discharge of inductance 32. Current IL then keeps on flowing through inductance IL while decreasing and divides into a first portion which successively flows through overall light-emitting diodes D1 and D2 and a second portion which successively crosses overall light-emitting diodes D3 and D4.

At time t3, current IL decreases below threshold IINF. Control unit 36 then orders the turning-on of switch 38. Current IL starts flowing again while rising between terminal IN1 and terminal IN2, successively through overall light-emitting diode D2, through inductance 32, from node G to node E, and through light-emitting diode D3. Current IL keeps on increasing until it exceeds threshold ISUP at time t4. Switch 38 is then off until current IL decreases below threshold IINF at time t5.

The cycle between times t2 and t4 is repeated as long as input voltage VIN is sufficiently high. Currents ID1, ID2, ID3 and ID4 then remain between IINF and ISUP.

At time t6, input voltage VIN decreases so that current IL remains below threshold ISUP. Switch 38 then remains on.

At time t7, input voltage VIN is no longer sufficiently high for a current to flow between input terminals IN1 and IN2.

At time t8, input voltage VIN cancels and starts a negative halfwave. Switch 38 is on. Overall light-emitting diodes D1 and D4 are forward-biased while overall light-emitting diodes D2 and D3 are reverse-biased. When input voltage VIN is sufficiently high in absolute value at time t9, the current starts flowing between terminals IN1 and IN2 successively through overall light-emitting diode D4, through inductance 32, from node G to node E, and through light-emitting diode D1.

At time t10, current IL exceeds threshold ISUP. The current regulation between IINF and ISUP is performed as previously described between times t2 and t6.

At time t11, input voltage VIN decreases so that current IL remains below threshold ISUP and switch 38 remains on.

At time t12, input voltage VIN is no longer sufficiently high in absolute value for a current to flow between input terminals IN1 and IN2.

The halfwave stops at time t13 when input voltage VIN reaches zero.

When input voltage VIN is sufficiently high for overall light-emitting diode D1 or D2 to be conductive, current-limiting circuit 30 enables to keep the current, flowing through the overall light-emitting diode D1 or D2 which is conductive, between thresholds IINF and ISUP. Advantageously, optoelectronic circuit 20 comprises means for modifying thresholds IINF and ISUP. Current-limiting circuit 30 then enables to control the current flowing through the overall light-emitting diodes and thus to control the light intensity emitted by optoelectronic circuit 20.

When the interval between thresholds IINF and ISUP is small, as is the case in FIG. 8, limiting circuit 20 plays the role of a regulation circuit capable of keeping the current flowing through the light-emitting diodes substantially equal to a current set point, for example equal to the average of thresholds IINF and ISUP. The interval between thresholds IINF and ISUP then represents the accuracy of the regulation around the current set point. As an example, the interval between thresholds IINF and ISUP is smaller than 10%, preferably smaller than 5%, of threshold IINF.

Advantageously, control unit 36 may be powered by a voltage obtained from the voltages across overall light-emitting diodes D1 to D4 or any other diode present in the assembly.

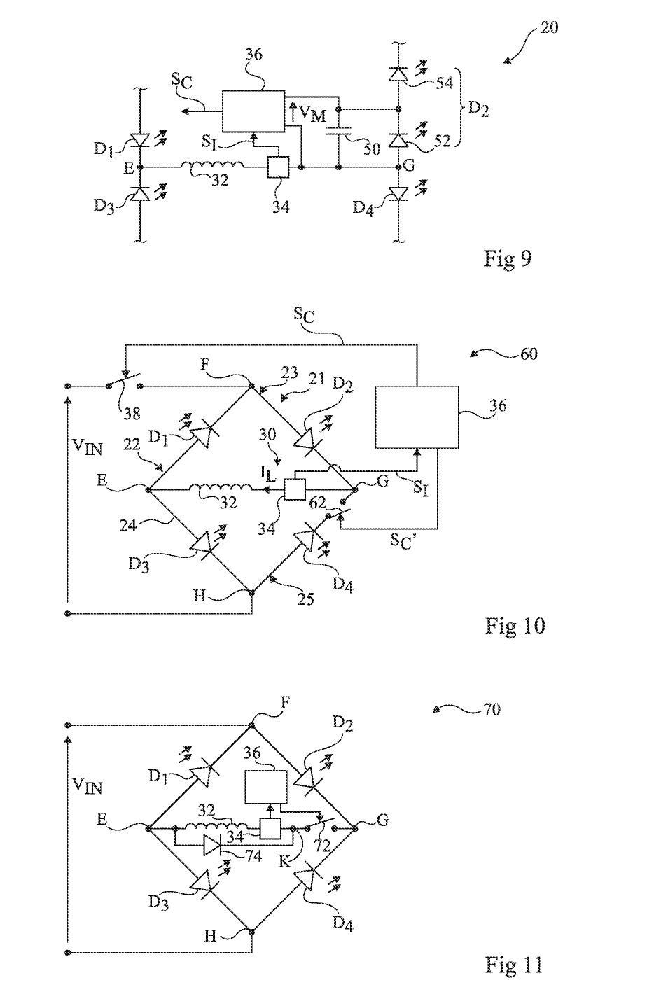

FIG. 9 is an electric diagram of an embodiment of a portion of optoelectronic circuit 20. Overall light-emitting diode D2 is shown in the form of two assemblies 52 and 54 of series-connected light-emitting diodes. A capacitor 50 is assembled in parallel across assembly 52 of light-emitting diodes. Control unit 36 is powered with voltage VM across capacitor 50. Capacitor 50 is charged each time overall light-emitting diode D2 is conductive. Voltage VM across capacitor 50 is substantially constant and may be used as a voltage for supplying the control unit. The number of elementary light-emitting diodes of assembly 52 is selected according to the desired voltage VM. As an example, voltage VM may be a few volts.

In the previously-described embodiment, when switch 38 is off, current IL flowing through inductance 32 distributes between branch 22 and branch 24. It may however be desirable to select in which branch the current will flow when switch 38 is off.

FIG. 10 shows another embodiment of an optoelectronic circuit 60 enabling to perform such a selection. Optoelectronic circuit 60 comprises all the elements of optoelectronic circuit 20 shown in FIG. 3 and further comprises a switch 62 located on branch 25, for example, between overall light-emitting diode D4 and node G. As a variation, switch 62 may be located on branch 24. Switch 62 is controlled by a signal S′C provided by control unit 36. Advantageously, the current always flows in the same direction between nodes H and G so that switch 62 can be a one-way switch.

Switch 38 may be controlled as previously described for optoelectronic circuit 20. Preferably, switch 62 is on when switch 38 is on and switch 62 is off when switch 62 is off. As a variation, switch 62 may be kept off all along the positive halfwave of voltage VIN and may be controlled as previously indicated for the negative halfwave of VIN. This advantageously enables to decrease the circuit power consumption and not to have to control switch 62 during positive halfwaves of power supply voltage VIN.

When switches 38 and 62 are off, inductance 32 discharges and the current flows through overall light-emitting diodes D1 and D2. As a variation, switch 62 may be located on branch 22 or on branch 23 if the current is desired to flow through overall light-emitting diodes D3 and D4 when switch 38 is off. As a variation, in addition to switch 62, another switch may be located on branch 23 or on branch 24. This enables to select one of branches 22 or 24 where the current will flow when switch 38 is off, such a selection being likely to vary along time.

FIG. 11 shows another embodiment of an optoelectronic circuit 70. Optoelectronic circuit 70 comprises all the elements of optoelectronic circuit 20 shown in FIG. 3, except that switch 38 is replaced with a switch 72, located between node G and a node K, inductance 32 and current sensor 34 being series-connected between node E and node K. Switch 72 is controlled by control unit 36. Optoelectronic circuit 70 further comprises a diode 74 assembled in parallel with inductance 32. As an example, the anode of diode 74 is connected to node E and the cathode of diode 74 is connected to node K. Diode 74 may be light-emitting.

Advantageously, the current always flows in the same direction between nodes G and E so that switch 72 can be a one-way switch.

The method of controlling switch 72 may be the same as that previously described for switch 32 in relation with optoelectronic circuit 20. Diode 74 enables to prevent the stopping of the current flowing through inductance 32 when switch 72 is off.

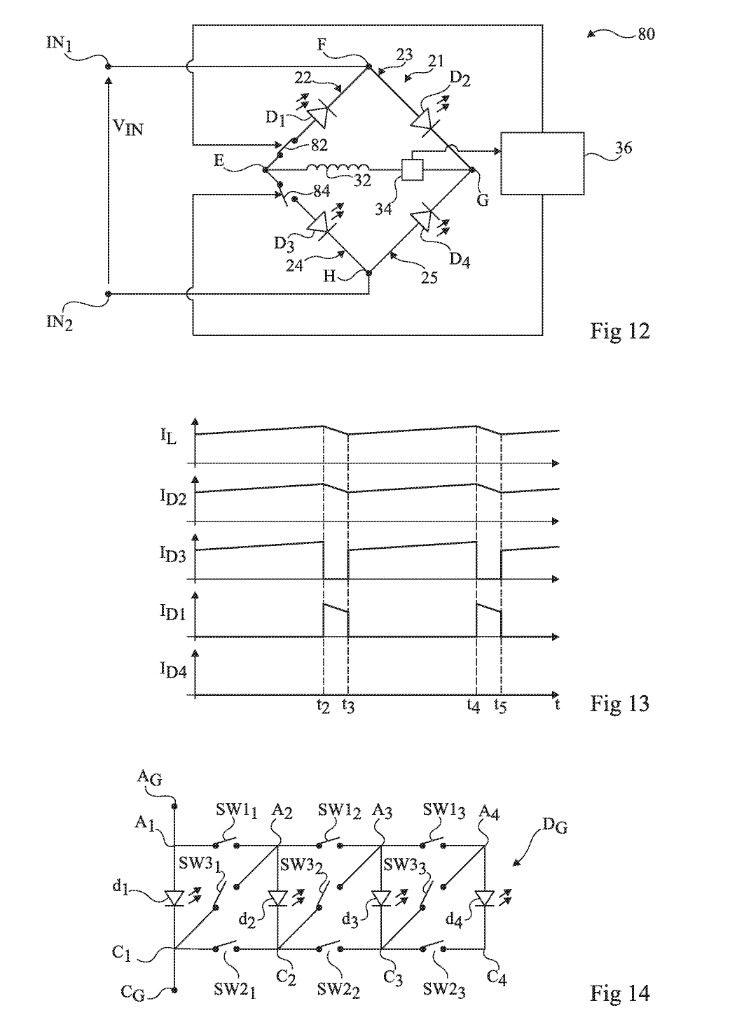

FIG. 12 shows another embodiment of an optoelectronic circuit 80. Optoelectronic circuit 80 comprises all the elements of optoelectronic circuit 20 shown in FIG. 3, with the difference that switch 38 is replaced with a first switch 82, located on branch 22, for example, between node E and overall light-emitting diode D3, and a second switch 84, located on branch 24, for example, between node E and overall light-emitting diode D2. As a variation, switch 82 may be located on branch 25 and switch 84 may be located on branch 23.

Switches 82 and 84 are controlled by control unit 36. Advantageously, the current always flows in the same direction between nodes E and F and between nodes E and H so that each switch 82, 84 may be a one-ways switch. Control unit 36 is further capable of detecting the sign of power supply voltage VIN. This may be performed by measuring the voltage across one of the elementary light-emitting diodes of one of overall light-emitting diodes D1 to D4.

An embodiment of the method of controlling switches 82, 84 will be described in relation with FIGS. 7 and 13.

Input voltage VIN increases from the zero value at time t0. Switches 82 and 84 are initially on. Overall light-emitting diodes D2 and D3 are forward-biased while overall light-emitting diodes D1 and D4 are reverse-biased. When input voltage VIN is sufficiently high at time t1, the current starts flowing between terminal IN1 and terminal IN2 successively through overall light-emitting diode D2, through inductance 32, from node G to node E, and through light-emitting diode D3.

At time t2, current IL exceeds threshold ISUP. Control unit 36 then controls the turning off of switch 84, switch 82 remaining on. Current IL then keeps on flowing through inductance IL while decreasing and successively crosses overall light-emitting diodes D1 and D2.

At time t3, current IL decreases below threshold IINF. Control unit 36 then orders the turning on of switch 84. Current IL starts flowing again while rising between terminals IN1 and IN2, successively through overall light-emitting diode D2, through inductance 32, from node G to node E, and through light-emitting diode D3. Current IL keeps on increasing until it exceeds threshold ISUP at time t4.

The cycle between times t2 and t4 is repeated several times as long as input voltage VIN is sufficiently high. Currents ID1, ID2, ID3 and ID4 then remain between IINF and ISUP.

At time t6, input voltage VIN decreases so that current IL remains below threshold ISUP. Switch 84 then remains on.

At time t7, input voltage VIN is no longer sufficiently high for a current to flow between input terminals IN1 and IN2.

At time t8, input voltage VIN cancels and starts a negative halfwave. Switches 82 and 84 are on. Overall light-emitting diodes D1 and D4 are forward-biased while overall light-emitting diodes D2 and D3 are reverse-biased. When input voltage VIN is sufficiently high in absolute value at time t9, the current starts flowing between terminals IN1 and IN2 successively through overall light-emitting diode D4, through inductance 32, from node G to node E, and through light-emitting diode D1.

At time t10, current IL exceeds threshold ISUP. The current regulation between IINF and ISUP is performed as previously described from time t2, with the difference that switch 84 remains on and switch 82 is off.

At time t11, input voltage VIN decreases so that current IL remains below threshold ISUP and switch 84 remains on.

As a variation, current sensor 34 may be replaced with two current sensors, one being arranged on branch 22 or 25 and the other being arranged on branch 23 or 24.

In FIG. 7, between times t0 and t1, t7 and t9, and t12 and t13, input voltage VIN is not sufficiently high for overall light-emitting diodes D1 and D4 or D2 and D3 to be conductive. There thus is no light emission. To decrease the duration of phases when no light is emitted, the elementary light-emitting diodes which form each overall light-emitting diode may be connected to one another by a switch network. The switches are then controlled to modify the connection of the elementary light-emitting diodes so as to modify the threshold voltage of the overall light-emitting diode.

FIG. 14 shows an embodiment of an overall light-emitting diode DG having a variable threshold voltage which may correspond to one of previously-described overall light-emitting diodes D1, D2, D3 and D4. Overall light-emitting diode DG comprises, as an example, N elementary light-emitting diodes d1, d2, d3 and d4, N being an integer, preferably even, equal to four in FIG. 14. Overall light-emitting diode DG comprises an anode AG and a cathode CG. Each elementary light-emitting diode di, with i being an integer varying from 1 to N, comprises an anode Ai and a cathode Ci. For i varying from 1 to N−1, anode Ai is connected to anode Ai+1 by a switch SW1i. For i varying from 1 to N−1, cathode Ci is connected to cathode Ci+1 by a switch SW2i. For i varying from 1 to N−1, cathode Ci is connected to cathode Ai+1 by a switch SW3i.

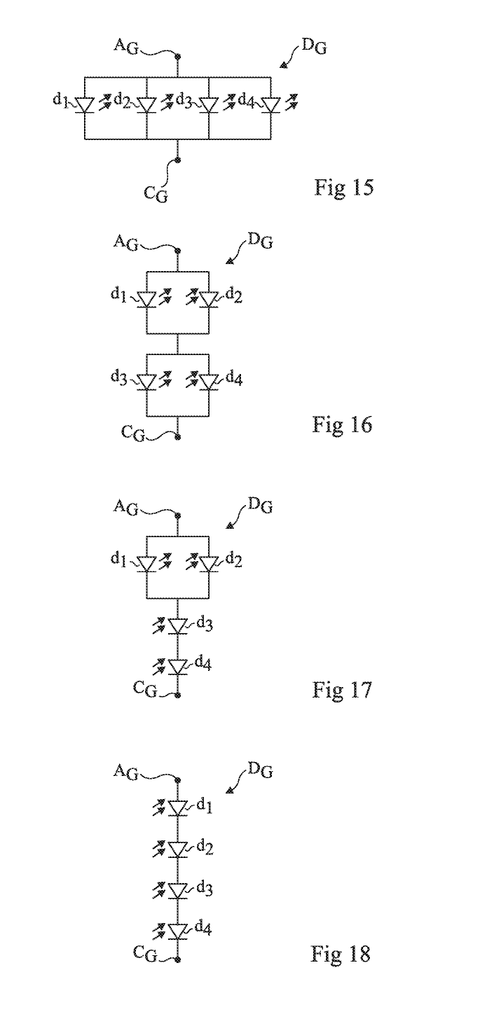

FIGS. 15 to 18 are equivalent electric diagrams of overall light-emitting diode DG of FIG. 14 for different on and off configurations of switches SW1i, SW2i and SW3i, with i varying from 1 to N−1.

In FIG. 15, switches SW1i and SW2i are on and switches SW3i are off for i varying from 1 to N. The N elementary light-emitting diodes di are then assembled in parallel.

In FIG. 16, for i varying from 0 to N/2, switches SW12i+1 and SW22i+1 are on, switches SW32i+1 are off, switches SW12i and SW22i are off, and switches SW32i are on. Elementary light-emitting diodes di are assembled in parallel in pairs, the pairs being series-connected.

In FIG. 17, switches SW11 and SW21 are on, switch SW31 is off, and for i varying from 2 to N, switches SW1i and SW2i are off and switch SW3i is on. Elementary light-emitting diodes d1 and d2 are assembled in parallel, this pair being series-connected to the other elementary light-emitting diodes.

The threshold voltage of overall light-emitting diode DG increases from the configuration shown in FIG. 15 to the configuration shown in FIG. 18. Thereby, switches SW1i, SW2i and SW3i may be controlled according to input voltage VIN or according to the current flowing between input terminals IN1 and IN2 to successively pass through the configurations shown in FIGS. 15, 16, 17, and 18 when input voltage VIN increases. As an example, the passing from a configuration to another may be ordered when input voltage VIN exceeds, in absolute value, a threshold. As an example, the passing from a configuration to another may be ordered when the current flowing between input terminals IN1, IN2 decreases below a threshold.

Thereby, overall light-emitting diode DG may be conductive for a longer time period and the duration of light emission of the optoelectronic circuit may be increased.

Specific embodiments have been described. Various alterations, modifications, and improvements will occur to those skilled in the art. In particular, in the previously-described embodiments, the current-limiting circuit comprises an inductance 32 assembled between nodes E and G. However, the current-limiting circuit may be formed differently. It may in particular comprise constant current or current-limiting diodes (CLD). Further, in the previously-described embodiments, overall light-emitting diodes D1, D2, D3 and D4 are provided on each branch 22, 23, 24, 25. However, as a variation, overall light-emitting diodes D1, D2 may be provided on branches 22 and 23 only, each overall light-emitting diode D3 and D4 being replaced with a switch controlled by control unit 36 and which is off when the overall light-emitting diode D3 or D4 that it replaces would be forward-biased and which is on when the overall light-emitting diode D3 or D4 that it replaces would be reverse-biased during the variation of input voltage VIN.

1. An optoelectronic circuit comprising:
first and second input terminals intended to receive an AC voltage;
a fullwave rectifying circuit comprising first, second, third, and fourth branches, the first and second branches having a first common node connected to the first input terminal, the third and fourth branches having a second common node connected to the second input terminal, the first and third branches having a third common node and the second and fourth branches having a fourth common node, a first assembly of light-emitting diodes assembled on the first branch in the forward direction from the third node to the first node; and a second assembly of light-emitting diodes assembled on the second branch in the forward direction from the first node to the fourth node or on the third branch in the forward direction from the third node to the second node; and
a circuit for limiting the current flowing through the light-emitting diodes comprising an inductance assembled between the third node and the fourth node, a sensor of the current flowing through the inductance and at least one first switch provided on one of the first or third branches, between the third and fourth nodes, between the first input terminal and the first node or between the second input terminal and the second node and a unit for controlling the turning off and the turning on of the first switch, the control unit being connected to the sensor.

2. The optoelectronic circuit of claim 1, wherein the fullwave rectifying circuit further comprises a third assembly of light-emitting diodes assembled on the third branch in the forward direction from the third node (E) to the second node.

3. The optoelectronic circuit of claim 2, wherein the second assembly of light-emitting diodes is assembled on the second branch and wherein the fullwave rectifying circuit comprises a fourth assembly of light-emitting diodes assembled on the fourth branch in the forward direction from the second node to the fourth node.

4. The optoelectronic circuit of claim 1, wherein the current-limiting circuit is capable of maintaining the current between a first threshold and a second threshold when the first assembly of light-emitting diodes or the second assembly of light-emitting diodes is conductive.

5. The optoelectronic circuit of claim 4, further comprising means for modifying the first and second thresholds.

6. The optoelectronic circuit of claim 4, wherein the current-limiting circuit plays the role of a circuit for regulating the current flowing through the light-emitting diodes to a current set point.

7. The optoelectronic circuit of claim 4, wherein the control unit is capable of controlling the turning off of the first switch when the current flowing through the light-emitting diodes of the first assembly or of the second assembly is greater than the first threshold.

8. The optoelectronic circuit of claim 4, wherein the control unit is capable of controlling the turning on of the first switch when the current flowing through the light-emitting diodes of the first assembly or of the second assembly is smaller than the second threshold.

9. The optoelectronic circuit of claim 4, wherein the first switch is assembled on the first branch or the fourth branch and wherein the current-limiting circuit comprises a second switch assembled on the second branch or the third branch, the control unit being capable of controlling the turning-off of the first switch when the current flowing through the light-emitting diodes of the first assembly is greater than the first threshold and the AC voltage is of a first sign, and being capable of controlling the turning-off of the second switch when the current flowing through the light-emitting diodes of the second assembly is greater than the first threshold and the AC voltage is of a second sign opposite to the first sign.
